(19) United States
(12) Patent Application Publication
(10) Pub. No.: US 2026/0015856 A1
(43) Pub. Date: Jan. 15, 2026

(54) NOISE BARRIERS AND METHODS OF THEIR MANUFACTURE

(71) Applicant: James G. Thompson, Columbus, OH (US)

(72) Inventor: James G. Thompson, Columbus, OH (US)

(21) Appl. No.: 19/336,053

(22) Filed: Sep. 22, 2025

Related U.S. Application Data
(63) Continuation-in-part of application No. 17/367,771, filed on Jul. 6, 2021, now Pat. No. 12,442,182.
(60) Provisional application No. 63/049,976, filed on Jul. 9, 2020.

(51) Int. Cl. E04B 1/86; B44F 9/02; B44F 9/04; E04B 1/84; G10K 11/168

(52) U.S. Cl. CPC E04B 1/86; B44F 9/02; B44F 9/04; G10K 11/168; E04B 2001/8461

(57) ABSTRACT

The present invention relates to a noise barrier wall panel that is lighter and more structurally sound than existing concrete noise barrier wall panels. The panel has a metal frame that is reinforced via metal strapping in key areas to prevent sagging. The panel has a plurality of layers forming a laminate that can be fixedly attached to the frame. A finish coating layer may have a plurality of designs, logos, symbols, or textures which may mimic building materials or scenery.

### CROSS-REFERENCES TO RELATED APPLICATIONS

This application is a continuation-in-part of U.S. patent application Ser. No. 17/367,771, filed Jul. 6, 2021, which claims priority to U.S. Provisional Application No. 63/049,976, filed Jul. 9, 2020, both of which are incorporated herein by reference in their entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

The present invention relates generally to the field of materials for noise barriers. More specifically, the present invention relates to an improved noise barrier wall panel that is lighter and more structurally sound than existing concrete noise barrier wall panels. The panel is comprised of a metal frame that is reinforced via metal strapping in key structural areas to prevent sagging, bending or warping. The panel also includes a plurality of layers that can be fixedly attached to the frame. The layers may include an insulation layer, at least one sheathing layer, an air and weather barrier layer, a covering coating layer, a basecoat and mesh layer and a finish coating or surface layer. Further, the finish coating or surface layer may have a plurality of designs, logos, symbols or textures, which may mimic building materials, aesthetic structural features or scenery. Accordingly, the present disclosure makes specific reference thereto. Nonetheless, it is to be appreciated that aspects of the present invention are also equally applicable to other like applications, devices and methods of manufacture.

Noise produced by traveling vehicles, construction sites, playgrounds, athletic fields and the like can be extremely disturbing and unpleasant to nearby homes, businesses and other establishments that may border roadways, streets, highways, schools, industrial areas, etc. As a result, noise barrier walls are frequently installed between roadways, other noisy areas and neighboring homes or establishments to disrupt sound waves produced by roadway traffic, equipment or people using facilities and to prevent noise pollution from entering into other areas. Typical noise barrier walls may be constructed from earth, concrete, masonry, wood or metal.

Existing noise barriers walls are extremely heavy and are typically made of concrete. As a result, a significantly large number of deliveries are required to bring the prefabricated noise barrier wall panel sections to the construction site of the wall. In addition, concrete may crack or crumble over time and such cracking may in fact be precipitated by the sound waves emanating from the noise-generating areas. The high number of deliveries is mainly due to the weight of each panel section of the wall, which may weigh as much as eight tons or 16,000 lbs. As a result, only a small number of panels may be delivered at any one time typically using one semi-truck, which results in hundreds of deliveries via multiple trucks during construction of a typical noise barrier wall. A sound barrier may consists of around 500 individual 8 ft×24 ft panels. In addition, existing concrete noise barrier wall panels require heavy machinery to lift each panel into place while constructing a wall due to their weight. Further, due to the extreme length of each panel, noise barrier wall panels of existing designs are often prone to sagging near the middle portion of the panel.

Furthermore, existing concrete noise barrier walls are extremely limited in their design and appearance, which is a result of the workable nature and finishing capabilities of concrete. As such, existing noise barrier walls cannot typically be adorned with complex decorative icons, colors or be designed to mimic a wide variety of materials and textures which would make the panels more aesthetically appealing. Likewise, existing noise barrier walls are limited in their dimensions due to the structural workability of concrete and are often designed to prioritize structural loading over wind loading. As a result, existing noise barrier walls may be prone to damage during extremely high winds due to lack of proper reinforcement, as well as cracking due to the freezing and thawing of water that may seep into the concrete panels. Concrete panels may also deteriorate over time due to being exposed to high decibel levels which are found near sound generating areas such as roadways, construction sites and the like.

Therefore, there exists a long-felt need in the art for an improved noise barrier wall panel. There also exists in the art a long-felt need for an improved noise barrier wall panel that is less susceptible to sagging and structural weaknesses that occur in existing noise barrier walls. Further, there is a long-felt need in the art for a noise barrier wall panel that is lighter than existing noise barrier walls such that more panel sections can be transported in fewer trips when constructing a barrier wall. There is a need for a barrier wall material that would lend itself to a larger number of installation sites. Finally, there exists a long-felt need in the art for an improved noise barrier wall panel that can be adorned with a plurality of complex decorative icons/colors or can be designed to mimic a plurality of materials and textures.

The subject matter disclosed and claimed herein, in one embodiment thereof, comprises an improved noise barrier wall panel. The panel is comprised of a metal frame that includes metal strapping that reinforces the frame to prevent sagging and structural weakness. The panel also has a plurality of layers. The layers may include: an insulation layer, at least one sheathing layer, an air and weather barrier layer, a covering coating layer, a basecoat and mesh layer and a finish coating layer. Further, the finish coating layer may have a plurality of decorative finishes of differing colors, textures, images, logos, symbols, simulated architectural elements and features, etc.

In this manner, the improved barrier wall panel of the present invention accomplishes all of the forgoing objectives and provides an extremely lightweight barrier wall panel that does not contain concrete but does contain a plurality of structural or strapping members that reinforce the structure and prevent sagging. As a result, each panel is much lighter than conventional concrete panels, and therefore can be moved much easier with fewer delivery trips and without the need for heavy duty machinery. In addition, the panels are more readily adaptable to other areas which previously may have been unsuitable for heavy concrete panels. Further, the finish coating of the panel allows for the panel to be designed with any number of exterior finishes and designs that are otherwise unavailable to existing noise barrier walls of concrete construction.

### BRIEF SUMMARY

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises an improved noise barrier or sound reduction wall panel. The panel in one embodiment is comprised of a metal frame made from cold-formed steel. The frame includes a plurality of metal strapping that reinforces the frame at each corner, and diagonally through the middle or central section of the frame. As a result, the frame is prone to much less sagging (if any) and other structural weaknesses that exist in conventional concrete barrier wall panels. In a further embodiment of the frame, the frame may contain a door frame or window ports to allow for the installation of a door to allow for travel access through the wall or panel or to provide visibility as to what is occurring on the other side of the panel.

A plurality of layers can then be fixedly attached to the frame to form the panel. The first layer may include an insulation layer that has noise or sound decibel reducing properties. The next layer is a sheathing layer of cement board, which can be installed in sections to the frame. Cement board is a mixture of glass fibers and cement and forms a strong generally impact-resistant layer that can be cut into various sizes. A plurality of additional layers can then be installed on either side of the cement board sheathing layer. Additional layers may include an air and weather barrier layer, a covering coating layer, a basecoat and mesh layer and a finish coating or surface layer. Further, the finish coating or surface layer may have a plurality of decorative finish options such as differing colors, textures, images, logos, symbols, and architectural and other aesthetically appealing elements.

As a result, the improved noise barrier and sound reduction wall panel of the present invention is particularly advantageous as it does not contain traditional concrete. Therefore, the panel is far lighter in weight than existing concrete noise barrier wall panels. As such, a greater number of barrier wall panels can then be more easily transported in fewer trips to a building site and installed without the typical type of heavy-duty machinery required to install heavy concrete noise wall panels. Further, the finish layer of the panel allows the panel to be designed with a plurality of differing textures, material, colors, finishes, etc. that are not easily achievable with concrete noise barrier walls, due to the functional limitations of concrete and the requirement to produce multiple and expensive molds to create unique design elements for the panels.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

According to an aspect of the present disclosure, a noise abatement panel is provided. The noise abatement panel comprises a rigid frame comprising a plurality of vertical frame members and a plurality of horizontal frame members. The plurality of horizontal frame members comprises a top rail and a bottom rail. The plurality of vertical frame members comprises a first end post, a second end post, and a plurality of intermediate vertical frame members. The noise abatement panel further comprises a plurality of diagonal bracings comprising at least two nonintersecting diagonal bracings, each diagonal bracing including an upper joint and a lower joint. The upper joint of each of the at least two nonintersecting diagonal bracings is arranged at an intersection of at least one of the plurality of horizontal frame members and a corresponding one of the first end post or the second end post. The lower joint of each of the at least two nonintersecting diagonal bracings is arranged at an intersection of at least one of the plurality of horizontal frame members and at least one of the plurality of intermediate vertical frame members. The noise abatement panel also comprises a cover layer and a sheathing layer, interposing the cover layer and the rigid frame, comprising cement board.

According to other aspects of the present disclosure, the noise abatement panel may include one or more of the following features. One of the at least two nonintersecting diagonal bracings may be arranged at a rear surface of the rigid frame, and another of the at least two nonintersecting diagonal bracings may be arranged at a front surface of the rigid frame. The at least two nonintersecting diagonal bracings may be arranged about a vertical axis extending through the top rail and the bottom rail. The at least two nonintersecting diagonal bracings may be vertically offset. The at least two nonintersecting diagonal bracings may be arranged in parallel. The noise abatement panel may further comprise a plurality of vertical bracings. Each of the plurality of vertical bracings may be aligned with at least a portion of a corresponding one of the plurality of intermediate vertical frame members. The upper joint of each of the at least two nonintersecting diagonal bracings may be arranged at an intersection of the top rail and a corresponding one of the first end post or the second end post, and the lower joint of each of the at least two nonintersecting diagonal bracings may be arranged at an intersection of the bottom rail and a corresponding one of the plurality of intermediate vertical frame members. The plurality of diagonal bracings may comprise a first pair of nonintersecting diagonal bracings and a second pair of nonintersecting diagonal bracings. The upper joint of each of the first pair of nonintersecting diagonal bracings may be arranged at an intersection of the top rail and a corresponding one of the first end post or the second end post, and the lower joint of each of the first pair of nonintersecting diagonal bracings may be arranged at an intersection of one of the plurality of horizontal frame members and a corresponding one of the plurality of intermediate vertical frame members. The upper joint of each of the second pair of nonintersecting diagonal bracings may be arranged at an intersection of an intermediate one of the plurality of horizontal frame members and a corresponding one of the first end post or the second end post, and the lower joint of each of the second pair of nonintersecting diagonal bracings may be arranged at an intersection of the bottom rail and a corresponding one of the plurality of intermediate vertical frame members. The upper joint of each of the first pair of nonintersecting diagonal bracings may be arranged at an intersection of a corresponding one of at least one of the plurality of horizontal frame members and one of the first end post or the second end post, and the lower joint of each of the first pair of nonintersecting diagonal bracings may be arranged at an intersection of a corresponding one of the plurality of horizontal frame members and one of the plurality of intermediate vertical frame members. The cover layer may comprise a tactile feature. The tactile feature may be configured to mimic at least one of a tree, a bush, a hedge, a mountain, a hillside, a garden, or a flower. The cover layer may comprise a silicone based anti-graffiti coating. The noise abatement panel may further comprise a noise-reducing insulation layer, a weather barrier layer, a basecoat, and a mesh coating layer. The mesh coating layer may comprise a fiberglass. The cover layer may comprise an acrylic coating.

According to another aspect of the present disclosure, a method of manufacturing a noise abatement panel is provided. The method comprises providing a plurality of vertical frame members and a plurality of horizontal frame members, the plurality of horizontal frame members comprising a top rail and a bottom rail, and the plurality of vertical frame members comprising a first end post, a second end post, and a plurality of intermediate vertical frame members. The method further comprises assembling the plurality of vertical frame members and the plurality of horizontal frame members to form a rigid frame. The method also comprises providing a plurality of diagonal bracings comprising at least two nonintersecting diagonal bracings, each diagonal bracing including an upper joint and a lower joint. The method additionally comprises attaching the plurality of diagonal bracings to the rigid frame with the upper joint of each of the at least two nonintersecting diagonal bracings arranged at an intersection of at least one of the plurality of horizontal frame members and a corresponding one of the first end post or the second end post, and the lower joint of each of the at least two nonintersecting diagonal bracings arranged at an intersection of at least one of the plurality of horizontal frame members and at least one of the plurality of intermediate vertical frame members. The method further comprises applying a sheathing layer comprising cement board to the rigid frame and applying a cover layer over the sheathing layer.

According to other aspects of the present disclosure, attaching the plurality of diagonal bracings may comprise securing one of the at least two nonintersecting diagonal bracings at a rear surface of the rigid frame and securing another of the at least two nonintersecting diagonal bracings at a front surface of the rigid frame.

### BRIEF DESCRIPTION OF THE SEVERAL VIEWS OF THE DRAWINGS

The description refers to provided drawings in which similar reference characters refer to similar parts throughout the different views, and in which:

FIG. 1 illustrates a perspective view of one potential embodiment of a noise barrier wall panel of the present invention in accordance with the disclosed specification;

FIG. 2 illustrates a perspective view of one potential embodiment of a frame of a noise barrier wall panel of the present invention in accordance with the disclosed structure;

FIG. 3A provides an enhanced perspective view of one potential embodiment of strapping connection of the top corner of a frame of a noise barrier wall panel of the present invention in accordance with the disclosed description;

FIG. 3B shows an enhanced perspective view of one potential embodiment of strapping connection of the bottom corner of a frame of a noise barrier wall panel of the present invention in accordance with the disclosed specification;

FIG. 3C displays an enhanced perspective view of one potential embodiment of strapping connection of a diagonal intersection of a frame of a noise barrier wall panel of the present invention in accordance with the disclosed framework;

FIG. 4 depicts a perspective view of another potential embodiment of a frame of a noise barrier wall panel of the present invention in accordance with the disclosed specification;

FIG. 5 illustrates a cross-sectional view of one potential embodiment of a noise barrier wall panel of the present invention in accordance with the disclosed structure;

FIG. 6 provides a perspective view of one potential embodiment of a noise barrier wall panel of the present invention in accordance with the disclosed architecture;

FIG. 7 shows a further potential embodiment of a noise or sound barrier panel as disclosed in the present invention;

FIG. 8 is a still further potential embodiment of a noise or sound barrier having different aesthetic or architectural elements;

FIG. 9 is a block diagram showing an exemplary method of making a noise or sound barrier panel in accordance with the present invention; and

FIG. 10A shows a side view of an assembled wall in a supporting frame and multidimensional surface coverings; and

FIG. 10B provides a front view of a sound barrier wall showing different sized elements and components in accordance with the present invention

FIG. 11 illustrates a schematic view of a noise barrier panel frame structure with diagonal bracing, according to aspects of the present disclosure.

FIG. 12 depicts a schematic view of the noise barrier panel frame structure with multiple diagonal bracing elements, according to an aspect of the present disclosure.

FIG. 13 shows a schematic view of a noise abatement panel including a door frame space according to an aspect of the present disclosure.

FIG. 14 illustrates a sectional view of the noise barrier panel frame structure with cables, according to an embodiment.

### DETAILED DESCRIPTION

Reference will now be made in detail to embodiments of the present disclosure, one or more drawings of which are set forth herein. Each drawing is provided by way of explanation of the present disclosure and is not a limitation. Like reference numerals are used to refer to like elements throughout the drawings. In the following description, numerous specific details are set forth in order to provide a thorough understanding, but the innovation can be practiced without such specific details. In other instances, well-known structures and devices may be shown in block diagram form to facilitate the description. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. The figures are described only to facilitate the description of the embodiments and are not intended as an exhaustive description of the invention. An illustrated embodiment need not have all the aspects or advantages shown, and in other embodiments, any of the features described herein from different embodiments may be combined. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

As noted above, there is a long-felt need in the art for an improved noise barrier wall panel that overcomes the limitations and inefficiencies of existing and conventional concrete noise or sound barrier wall panels. The enumerated inefficiencies of conventional panels include the unnecessarily heavy weight of concrete noise barrier wall panels, which make them difficult to transport efficiently. Another inefficiency includes the lack of variations in appearance and aesthetics of existing concrete noise barrier walls, which are limited by the workability of concrete and the available molds to impart different designs. Further, sagging that may occur within the barrier wall, particularly the central section, as a result of lack of reinforcement is yet a further inefficiency of existing concrete noise barrier wall panels. Therefore, an improved noise barrier wall panel is desired that overcomes said shortcomings and provides a lightweight, structurally sound and aesthetically-pleasing barrier wall.

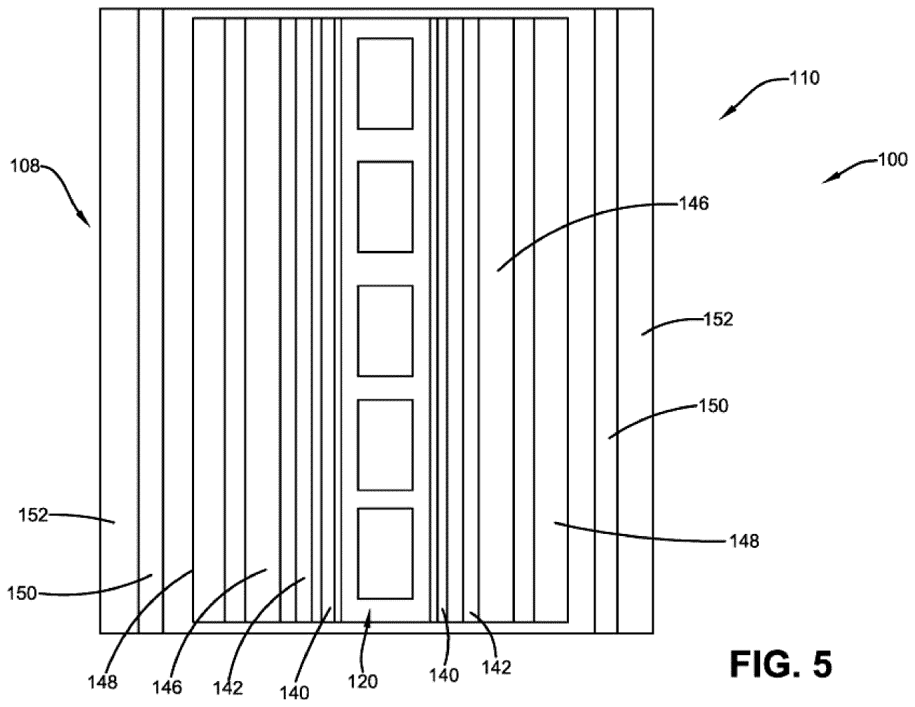

The present invention, in one exemplary embodiment, is comprised of an improved noise or sound barrier wall panel that can be used to construct a noise or sound barrier wall. The panel in one embodiment includes a generally rectangular cold-formed steel frame which is sized and configured to meet a particular or desired dimension for a construction project. The frame further includes a plurality of metal strapping elements that are located in all corners of the frame, and also in diagonal locations that extend through the center of the frame. In some aspects, the plurality of strapping elements may be located in the top corners of the frame and in diagonal locations present in the middle section of the frame. A plurality of layers can then be fixedly attached or otherwise secured to the frame and may be attached in a specific order via a particular method of assembly. One such combination of layers may include (in order of attachment to the frame) a noise-reducing insulation layer, at least one sheathing (e.g. cement board) layer which may be applied in various sections or regions of the wall panel, an air and weather barrier layer, a covering coating or surface layer, a basecoat and mesh layer and a finished coating layer. As depicted in FIG. 5, the ordering and positioning of layers is disclosed such that layers which are directly adjacent form a continuous interface, while non adjacent layers are separated by an intervening layer that is distinctly interposed between them. A POSITA will understand that in some specific orders of the plurality of layers, layers may be located adjacent or continuous with layers they are in direct contact with, and layers separated from one another via a third layer will have that third layer precisely located between them. Further, the finished coating layer may have a plurality of raised decorative elements such as images, logos, symbols, architectural configurations and other aesthetically-pleasing features. In addition, the finished layer may take on a variety of textures and appearances that resemble materials such as brick, stone, wood, etc.

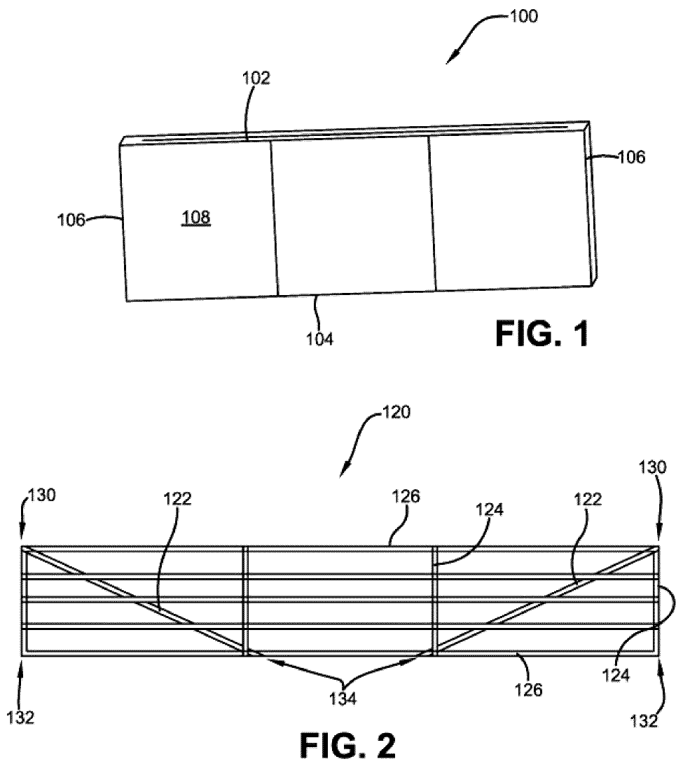

Referring initially to the figures, FIG. 1 illustrates a perspective view of one potential embodiment of a noise barrier or sound reduction wall panel 100 of the present invention in accordance with the disclosed specification. As will be more fully explained in detail below, the noise barrier or sound-reduction wall panel 100 is preferably made from a metal frame 120 and at least one layer of sheathing 142 is attached to the metal frame 120. While sheathing layer may be used herein to refer to a panel layer attached to the frame to provide rigidity and a base for further layers, such structure may also be referred to herein as sheathing 142 without deviating from the inventive disclosure contemplated herein. While rigid frame may be used herein to refer to the structural frame element comprising interconnected vertical and horizontal frame members, such structure may also be referred to herein as metal frame 120 without deviating from the inventive disclosure contemplated herein. The panel 100 may also have a plurality of additional layers above or over the sheathing layer 142, which includes but is not limited to: an air or weather barrier layer 146, a covering coating layer 148, a basecoat with a mesh finish layer 150 and an acrylic finishing coating layer 152. The coating or surface layer may include an anti-graffiti material such as a silicone or siloxane-based paint which forms a non-stick surface and repels paint and other unwanted coatings or debris. While cover layer may be used herein to refer to one or more layers disposed outwardly of the sheathing layer to provide a finished appearance and/or protective properties, such structure may also be referred to herein as covering coating layer 148 or finish coating layer 152 without deviating from the inventive disclosure contemplated herein.

The noise wall or sound reduction barrier panel 100 is also preferably lightweight. In certain embodiments, the panel 100 may weigh approximately 20 lb/ft² or less; and in other embodiments, about 8 lb/ft² or less. It is also contemplated that in differing embodiments the panel 100 may have a plurality of different dimensions allowing the panel 100 to be easily configurable to meet a particular job or application. However, the preferred dimensions are 8 ft×24 ft or 4 ft×24 ft for each panel 100. The preferred shape of each panel 100 is square or rectangular, such that each panel 100 has a top surface 102 and a generally parallel bottom surface 104, which is generally fully coextensive with the top panel, two generally parallel sidewalls 106, and a generally parallel front surface 108 and rear surface 110. However, in differing embodiments the panel 100 may differ in shape and may be any polygonal or geometric shape that is straight or curved. In addition, other fanciful designs or configurations are of course possible in connection with the panel due to the particular make-up of the panel. It is also preferred but not required that in at least one embodiment, the panel 100 and all components are made of environmentally-friendly materials, including renewable and recyclable materials, such that the panel 100 may achieve LEED (Leadership in Energy and Environmental Design) certification.

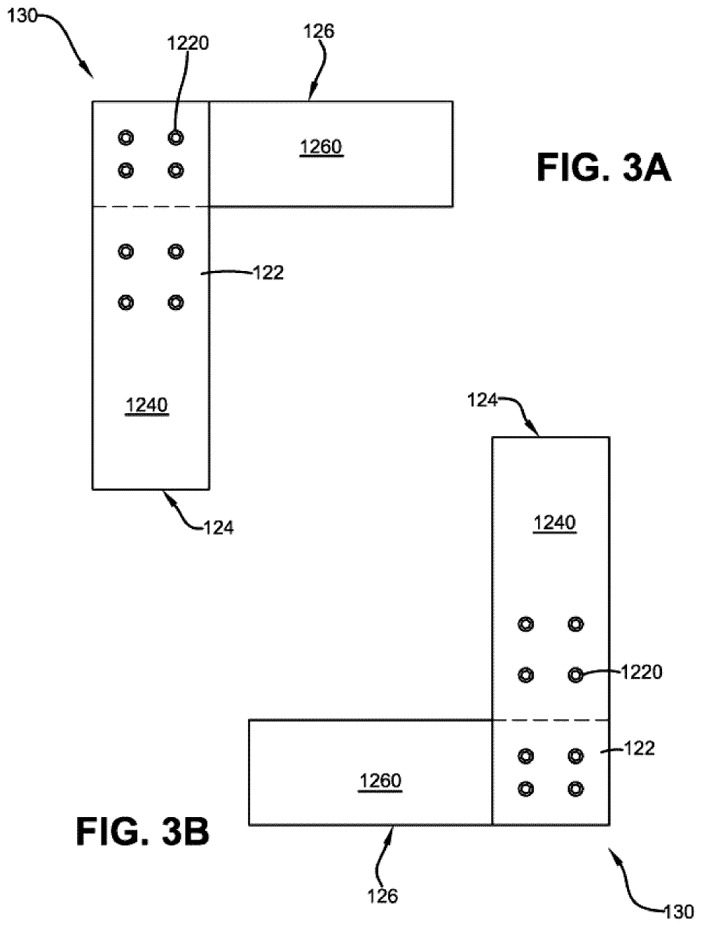

As seen in FIG. 2, the metal frame 120 of the panel 100 is preferably generally rectangular in shape. In differing embodiments, the frame 120 may be comprised of a plurality of cold-rolled or cold-formed metals, such that said metals meet any mechanical and chemical requirements that are standard to the industry (e.g., ASTM 1003). In one embodiment of the panel 100, the frame 120 may have a G60-G90 galvanized cold-rolled metal components that are screwed, fastened, adhered or welded together to form the frame. It is further contemplated that the frame can also be made up of any number and combination of the following components: (a) 6″-14 Gauge Studs at no less than 9¼″ on center with no less than G60 Coating (b) a 6¼×6¼%″ (approx.)—14 Gauge End Track (c) 2″ wide×16 Gauge cold rolled Strapping (d) 6″-18 Gauge Studs with no less than G60 coating (e) 6″-14 Gauge Lifting Stud with 3″ diameter hole punch that allows for the lifting of the panel (f) 4⅝″×7″×⅜ Bearing Plate Galvanized per CMS 711.02 (g) 4″-18 Gauge Stud to act as a keyway for the stud above.

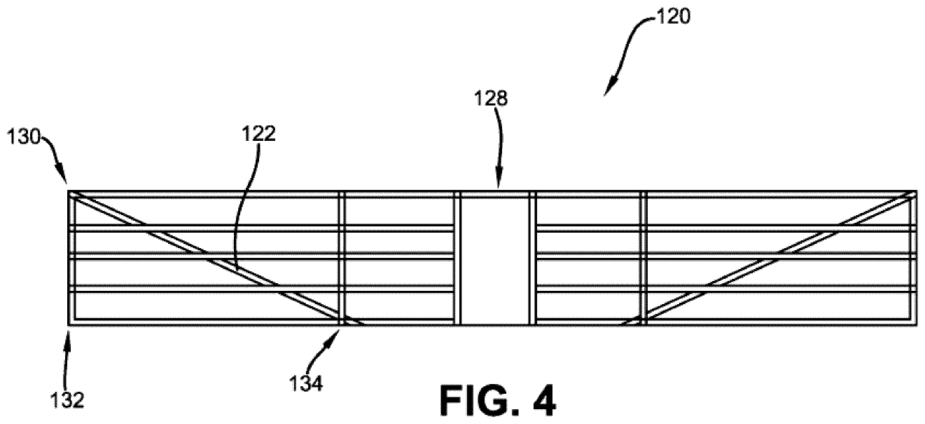

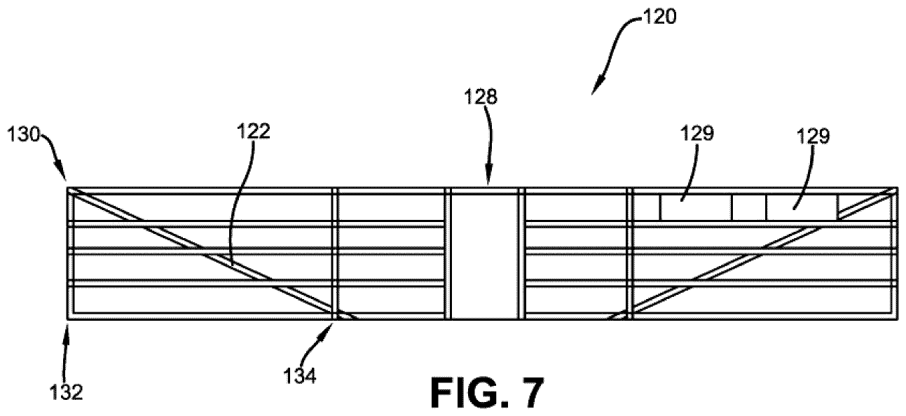

It is further contemplated that said materials may be used to make up any number or combination of the vertical frame members 124 and horizontal frame members 126 of the frame 120. While top rail may be used herein to refer to the uppermost horizontal frame member of the rigid frame, such structure may also be referred to herein as horizontal frame member 126 without deviating from the inventive disclosure contemplated herein. While bottom rail 126b may be used herein to refer to the lowermost horizontal frame member of the rigid frame, such structure may also be referred to herein as horizontal frame member 126 without deviating from the inventive disclosure contemplated herein. While first end post may be used herein to refer to the vertical frame member located at one end of the rigid frame, such structure may also be referred to herein as vertical frame member 124 without deviating from the inventive disclosure contemplated herein. While second end post may be used herein to refer to the vertical frame member located at the opposite end of the rigid frame, such structure may also be referred to herein as vertical frame member 124 without deviating from the inventive disclosure contemplated herein. While intermediate vertical frame members may be used herein to refer to the vertical frame members positioned between the first and second end posts, such structure may also be referred to herein as vertical frame members 124 without deviating from the inventive disclosure contemplated herein. Further, an additional embodiment of the panel 100 may include an access door frame 128 or window 129 (see FIG. 7) within the panel 100 that can be used to attach an access door or window within the panel 100, as seen in FIG. 4 (and FIG. 7, respectively). Accordingly, the access door can be used to allow individuals to travel through the panel 100 or wall for maintenance or convenience purposes, and windows can be used to view activity on the other side of the wall as well as to check to see if it is safe to open the door and cross beyond the panel.

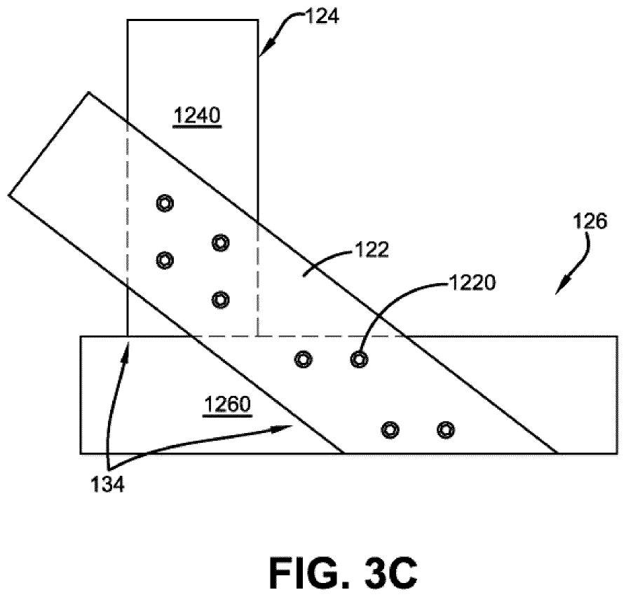

Each panel 100 may have a plurality of strapping elements 122, which may be made of any of the materials listed supra. While diagonal bracings may be used herein to refer to reinforcing members extending diagonally between frame intersections, such structure may also be referred to herein as strapping elements without deviating from the inventive disclosure contemplated herein. The strapping elements 122 further improve the strength of the panel 100 and prevents sagging and structural weakening from structural, stress, vibrational or wind loads. The strapping 122 is preferably removably attached via fasteners 1220 or fixedly attached via welding to the frame 120 before the application of sheathing 142. As shown in FIG. 3A, FIG. 3B, and FIG. 3C, the strapping 122 can be located in a plurality of locations within each panel 100. The locations may include the top corners 130, bottom corners 132, and diagonal intersections 134 of all or some areas of the frame 120. While upper joint may be used herein to refer to the connection point of a diagonal bracing at an upper portion of the rigid frame, such structure may also be referred to herein as connection point at top corners 130 or diagonal intersections 134 without deviating from the inventive disclosure contemplated herein. While lower joint may be used herein to refer to the connection point of a diagonal bracing at a lower portion of the rigid frame, such structure may also be referred to herein as connection point at bottom corners 132 or diagonal intersections 134 without deviating from the inventive disclosure contemplated herein. As shown in FIG. 2, the diagonal intersections 134 may be located at an intersection of the vertical member 124 and the horizontal member of 126 that is not in the bottom corner of 132 of the frame 120. In this manner, the frame 120 may include a pair of the vertical members 124 arranged between the vertical members 124 that are arranged at lateral edges of the frame 120 of a panel 100.

FIG. 3A illustrates an enhanced perspective view of one potential embodiment of the strapping 122 connection used for the top corner of a frame 120 of a noise barrier wall panel 100 of the present invention in accordance with the disclosed framework. in some aspects, an end of the strapping 122 secured to the top corner of the frame 120 may be referred to herein as a first end of each strap of the strapping 122. It is contemplated that in this area of the frame 120, the strapping 122 is fastened to the front surface 1240 of the vertical frame member 124 and to the front surface 1260 of the horizontal frame member 126 via fasteners 1220 such as bolts. However, in a differing embodiment of the panel 100, the strapping 122 may be fixedly attached (e.g. welded) or removably attached to each surface 1240, 1260.

FIG. 3B illustrates an enhanced perspective view of one potential embodiment of strapping 122 connection of the bottom corner 132 of a frame 120 of a noise barrier wall panel 100 of the present invention in accordance with the disclosed specification. It is contemplated that in this area of the frame 120, the strapping 122 is fastened to the front surface 1240 of the vertical frame member 124 and to the front surface 1260 of the horizontal frame member 126 via fasteners 1220 such as bolts or screws. However, in a differing embodiment of the panel 100, the strapping 122 may be fixedly attached (e.g. welded) to each surface or layer 1240, 1260 as needed to create a secure structure.

FIG. 3C illustrates an enhanced perspective view of one potential embodiment of strapping 122 connection of a diagonal intersection 134 of a frame 120 of a noise or sound barrier wall panel 100 of the present invention in accordance with the disclosed description. It is contemplated that in this area of the frame 120, the strapping 122 is fastened or otherwise secured to the front surface 1240 of the vertical frame member 124 and to the front surface 1260 of the horizontal frame member 126 via fasteners 1220 such as bolts, screws or other mechanical fasteners. However, in a differing embodiment of the panel 100, the strapping 122 may be fixedly attached (e.g. welded) to each surface 1240, 1260. This fastening may also occur in embodiments of the panel 100 that feature diagonal strapping 122, wherever the strapping 122 may contact any vertical frame member 124 and/or any horizontal frame member 126 within the frame 120.

As seen in FIG. 4, a plurality of sheathing 142 layers is then attached to one or both surfaces 108, 110 of the metal frame 120 to form a first layer. However, in one embodiment of the panel 100, insulation 140 may be used as a base layer to which the sheathing 142 is applied. This sheathing 142 attachment process can be done by using any suitable type of screws (ex. cement board coated screws) and at any suitable amount of spacing. It is further contemplated that in the preferred embodiment of the panel 100, the sheathing 142 is comprised of 0.5 in. cement board, which is a composite of glass fibers and cement and can be cut relatively easily and formed into different shapes or configurations as needed. However, in differing embodiments of the panel 100 the sheathing 142 may differ in thickness as well as material type and may also include, but is not limited to: synthetic stucco or an exterior insulation and finish system (EIFS). As also noted above, one panel 100 may contain any number of sheathing 142 layers, with the lowest number of layers being at least one layer.

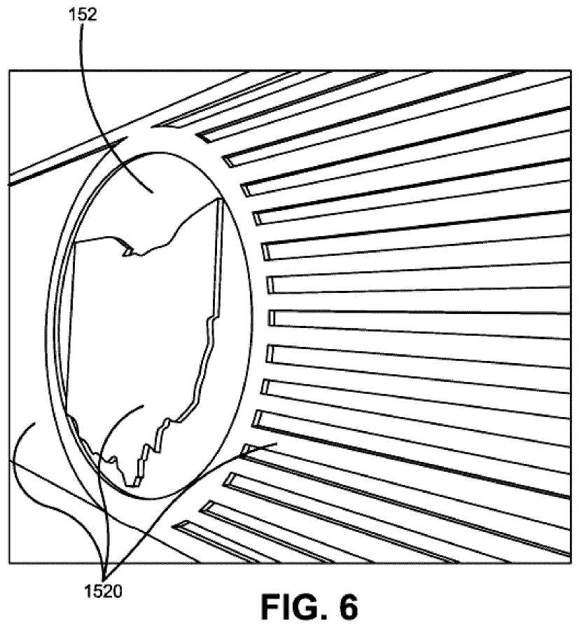

Additional layers may then be applied over top of and affixed to the at least one sheathing 142 layer (as shown in FIG. 5) in the following procedural method. However, it should be noted that the first steps of the method include the assembling of the frame 120 and strapping 122 arrangement as described above, and also includes the attachment of insulation 140 and sheathing 142 to the frame 120. First, an air and weather barrier 146 may be applied to the entire sheathing area 142 or applied only to the outer perimeters of the panel 100 at the interchange or connection of the sheathing 142 and metal frame 120. Next, the entirety or select portions of the sheathing 142 may receive a layer of covering or surface coating 148 to spot and/or cover all exposed the cement board or sheathing 142 joints and screw and fastener heads. Then, a combined basecoat and layer of fiberglass mesh 150 can be applied to the entire surface area of the sheathing 142. Layer 150 can also be applied to the entirety or a portion of the metal frame 120 prior to the attachment of the sheathing 142 to the frame 120. Finally, a finish layer of acrylic coating 152 may be applied over the basecoat and mesh layer 150. The finish layer 152 may also have any variety and number of different colors, textures, architectural elements and designs, as well as multiple raised (e.g. 3-dimensional) finish layers 1520 that have differing colors, textures and designs, as seen in FIG. 6. In addition, the finish layer 152 may have an imprinted (e.g., stamped or embossed) or raised texture providing a tactile feature that mimics building materials or imagery such as but not limited to: brick, stone, wood, cement, stucco, tile, rock, natural materials, trees, bushes, hedges, mountains, hillsides, gardens, flowers and combinations thereof.

In a further embodiment of the panel 100, an insulation layer 140 may be applied between the air and weather barrier layer 146 and the base coat mesh layer 150, or any two layers of the panel 100 (and between the frame 120 and sheathing 142 as noted above). Further, the insulation 140 may be made of an extruded polystyrene or polyurethane foam. However, it will be appreciated that the insulation 140 may be made of any variety of suitable materials including, for example, foam insulation, plywood, drywall, water resistant board, light gauge sheet metal, and combinations thereof. It is also contemplated that the insulation layer 140 is sound-dampening or noise-reflective or absorptive, such that the panel 100 itself becomes sound reflective, dampening or sound-absorptive. It is further contemplated that in some embodiments, the panel 100 may reduce noise levels by five dB or more, and even by 10 dB or more in further embodiments. Further, the finish layer 152 may have a plurality of coatings such as an anti-graffiti coating, smog-reducing coating, sound absorption coating, etc. and may also include embedded solar panels or photovoltaic cells.

In differing embodiments, the panel 100 may also be anchored by any of a variety of suitable methods. In at least one embodiment, helical piles may be used for foundations, as well as a specialized I-Beams or posts, which may be configured to a particular design. In such embodiments, the helical pile or other anchoring method utilized may be sufficient to satisfy all Department of Transportation (DOT) requirements and/or those requirements corresponding to each state's specifications.

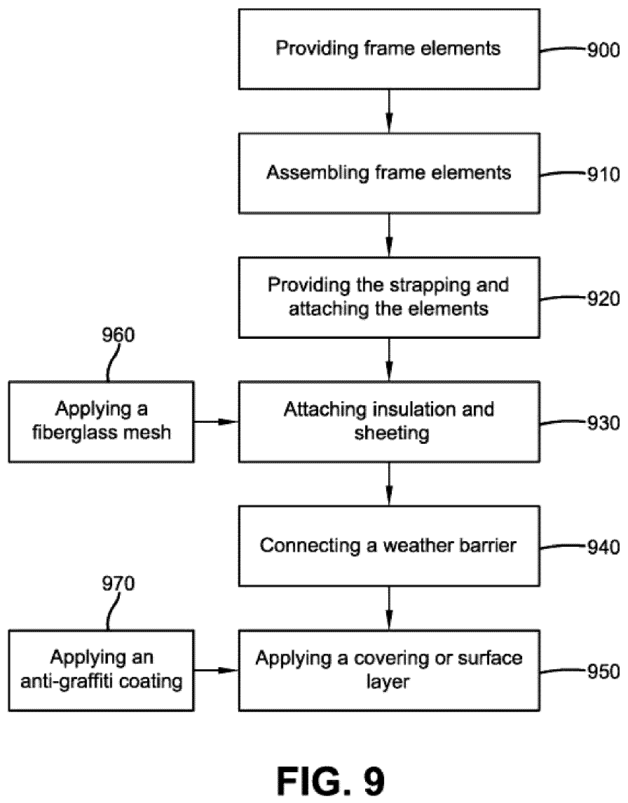

FIG. 9 provides an exemplary flow diagram of an exemplary method for producing the sound or noise barrier material. The method includes initially providing frame elements at step 900, then assembling the frame elements at step 910. Next, the strapping elements are provided and attached at step 920. Insulation and sheeting are attached to the frame at step 930 and then a weather barrier is connected at step 940. A covering or surface layer may be provided over the assembled laminate at step 950. In additional steps, a fiberglass mesh may be applied over the laminate at step 960 and an anti-graffiti coating may be applied at step 970.

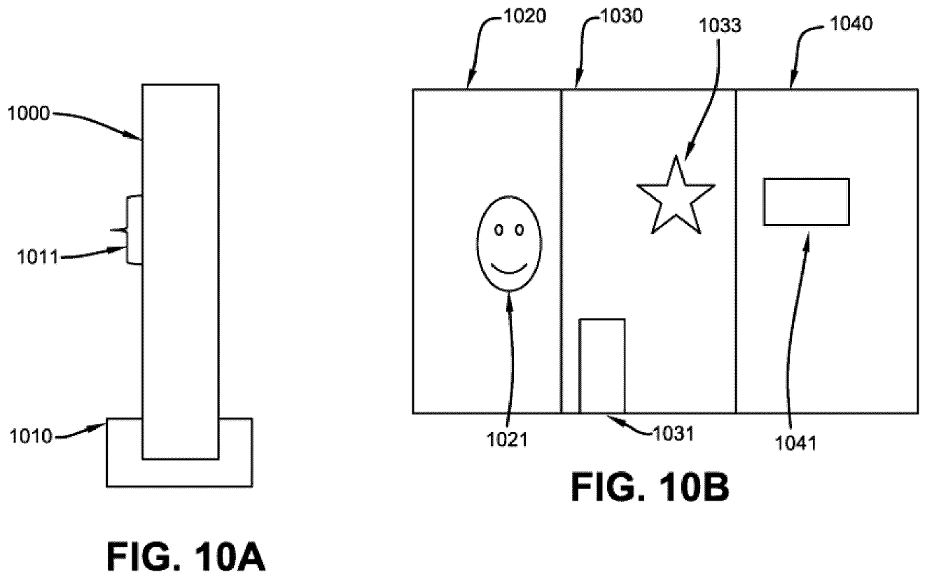

FIG. 10A shows a side view of a sound barrier or noise abatement wall structure 1000 which is positioned in a U shaped channel 1010 to support the wall panels in an upright configuration. In addition, FIG. 10A also shows a tactile element 1011 on the surface layer which provides a three-dimensional attribute of the wall structure 1000.

FIG. 10B provides a front view of a sound dampening or noise reduction wall having different sized wall panels 1020, 1030 and 1040. Panel 1020 includes an aesthetic element 1021, while panel 1030 has a door 1031 and a design element 1033. Panel 1040 shows a window element 1041 which can be used to view through the wall panels.

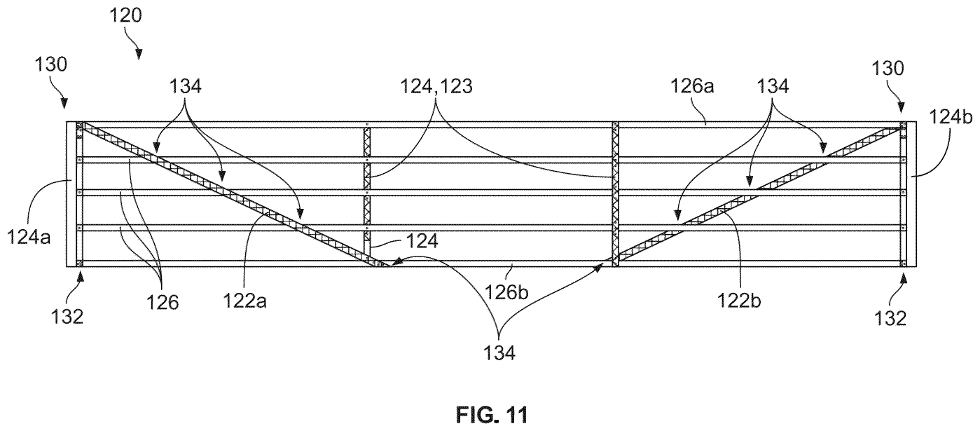

FIG. 11 depicts a frame 120 according to an additional exemplary aspect of the present disclosure. The frame 120 may include a plurality of vertical frame members 124 and a plurality of horizontal frame members 126 that are interconnected to form the structural skeleton of the noise abatement panel. The plurality of horizontal frame members 126 may include a top rail 126a and a bottom rail 126b that define the upper and lower boundaries of the rigid frame structure. In some cases, the top rail 126a may be positioned at the uppermost portion of the rigid frame, while the bottom rail 126b may be located at the lowermost portion to provide structural stability and load distribution. The horizontal frame members may also include intermediate horizontal members 126c, 126d, . . . , 126n positioned between the top rail 126a and bottom rail 126b to provide additional structural support and load transfer capabilities.

The plurality of vertical frame members 124 may include a first end post 124a, a second end post 124b, and a plurality of intermediate vertical frame members 124c, 124d, . . . , 124n that extend between the top rail 126a and bottom rail 126b. In some aspects, at least one of the vertical frame members 124 may extend only a portion of a length between the top rail 126a and the bottom rail 126b. The first end post 124a may be positioned at one lateral edge of the rigid frame, while the second end post 124b may be located at the opposite lateral edge to define the width of the panel structure. In some cases, the plurality of intermediate vertical frame members 124 may be positioned between the first end post 124a and second end post 124b at predetermined spacing intervals to provide structural reinforcement and load distribution throughout the rigid frame assembly. The vertical frame members 124 may be cold-formed steel studs with industry standard hole patterns unless noted otherwise, allowing for standardized connections and assembly procedures.

With continued reference to the figures, the steel components of the rigid frame may be galvanized according to ODOT CMS 711.02 and ASTM A123 standards to provide corrosion resistance and extended service life in outdoor environments. The galvanizing process may involve applying a protective zinc coating to the steel surfaces, which helps prevent rust and deterioration when exposed to moisture and environmental conditions. In some cases, the galvanized coating may range from G60 to G90 thickness depending on the specific application requirements and environmental exposure conditions.

The rigid frame may incorporate custom tracks designed for use with standard ODOT post types, allowing for compatibility with existing infrastructure and installation procedures. These custom tracks may be configured to interface with specific post configurations and provide secure connections between individual panel sections. In some cases, the custom tracks may include specialized dimensions and connection features that accommodate the particular requirements of ODOT standard drawings and installation specifications. The frame components may be screwed, fastened, adhered, or welded together to form the complete rigid frame assembly, with connection methods selected based on structural requirements and assembly considerations.

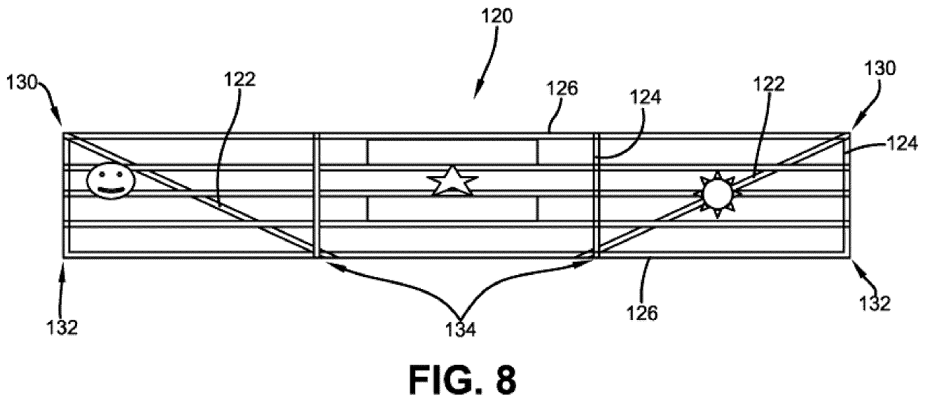

Referring to FIGS. 2, 4, 7, 8, and 11-13, the noise abatement panel includes a plurality of diagonal bracings (strapping elements 122) that provide enhanced structural reinforcement and prevent sagging or structural weakening under various load conditions. The plurality of diagonal bracings 122 may include at least two nonintersecting diagonal bracings that are strategically positioned throughout the rigid frame to distribute loads and maintain structural integrity. In some cases, the diagonal bracings 122 may be constructed from cold-rolled steel strapping material with dimensions of approximately 2 inches wide by 16 gauge thickness, providing adequate strength while maintaining flexibility for installation and connection procedures.

Each diagonal bracing 122 may include an upper joint and a lower joint that define the connection points where the diagonal bracing interfaces with the rigid frame structure. The upper joint of each of the at least two nonintersecting diagonal bracings may be arranged at an intersection of at least one of the plurality of horizontal frame members 126 and a corresponding one of the first end post 124a or the second end post 124b. As shown in FIGS. 2, 4, 7, 8, and 11-13, the upper joint connection may occur at the top corner (top corners 130) where the diagonal bracing interfaces with both the vertical frame member and horizontal frame member simultaneously. In some cases, the upper joint may be secured using mechanical fasteners (fasteners 1220) such as bolts or screws that penetrate through the diagonal bracing material and into the frame members to create a secure connection.

With reference to FIGS. 3A, 3B, 3C, and at least FIGS. 11-13, the lower joint of each of the at least two nonintersecting diagonal bracings 122 may be arranged at an intersection of at least one of the plurality of horizontal frame members 126 and at least one of the plurality of intermediate vertical frame members 124c, 124d, . . . , 124n. The lower joint configuration allows the diagonal bracing to transfer loads from the upper portions of the rigid frame down to intermediate support points, creating a distributed load path that enhances overall structural performance. In some cases, the lower joint may be positioned at diagonal intersections (diagonal intersections 134) where intermediate vertical frame members intersect with horizontal frame members at locations other than the bottom corners of the rigid frame.

The nonintersecting configuration of the diagonal bracings provides structural advantages by avoiding interference between individual bracing elements while maintaining load transfer capabilities throughout the rigid frame assembly. As further shown in at least FIGS. 11-13, the diagonal bracings 122 may be positioned such that each bracing element follows a distinct path from its upper joint to its lower joint without crossing or interfering with other diagonal bracing elements 122. In some cases, the nonintersecting arrangement allows for multiple diagonal bracings to be installed within the same panel section while maintaining independent load paths and connection points.

The connection details for the diagonal bracings 122 may incorporate standardized fastening procedures that accommodate field installation requirements and structural load specifications. In some cases, the diagonal bracings may be positioned to provide lifting points and rigging configurations for safe handling and installation procedures, with rigging angles maintained at minimum 55 degree chain angles to ensure proper load distribution during panel transportation and placement operations. The diagonal bracing system may also accommodate various panel configurations and dimensional requirements while maintaining consistent structural performance characteristics across different panel sizes and applications.

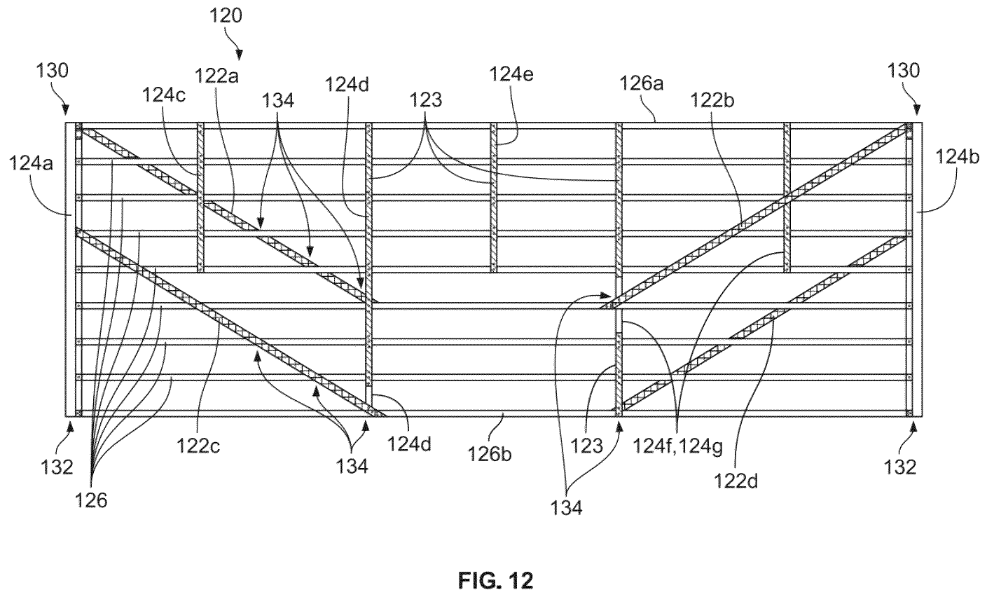

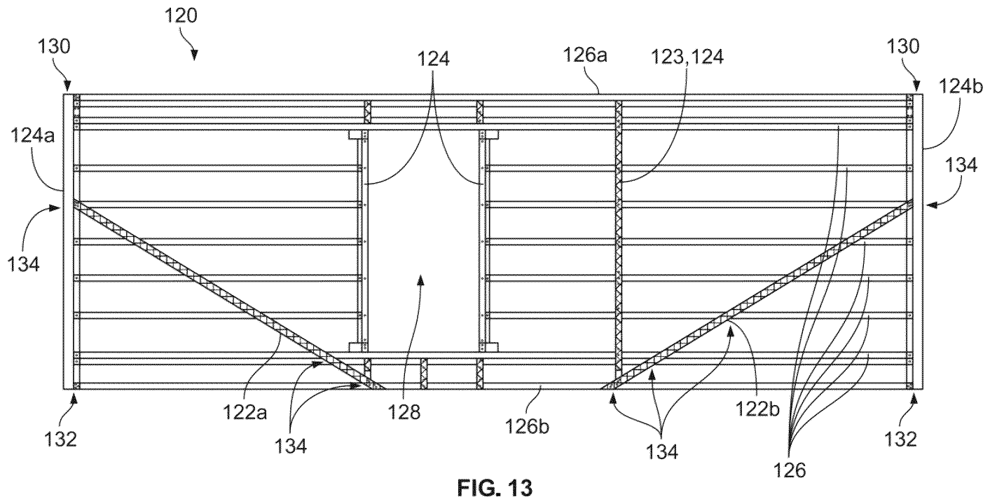

The diagonal bracings may be positioned on multiple surfaces of the rigid frame to provide enhanced structural reinforcement from different directional orientations. In some cases, one of the at least two nonintersecting diagonal bracings may be arranged at a rear surface of the rigid frame, while another of the at least two nonintersecting diagonal bracings may be arranged at a front surface of the rigid frame. In some aspects, diagonal bracings may be attached to front surfaces, rear surfaces, or a combination thereof of the frame members using mechanical fasteners that provide removable connections for maintenance or replacement purposes. In an exemplary aspect as depicted in FIG. 11, a first diagonal bracing 122a may be attached to the front surface whereas a second diagonal bracing 122b may be attached to the rear surface. In another exemplary aspect as depicted in FIG. 12, the first diagonal bracing 122a may be attached to the rear surface, the second diagonal bracing 122b may be attached to the front surface, a third diagonal bracing 122c may be attached to the front surface, and a fourth diagonal bracing 122d may be attached to the rear surface. In an exemplary aspect as depicted in FIG. 13, each of the first diagonal bracing 122a and the second diagonal bracing 122b may include diagonal bracings attached to both the front and rear surfaces of the frame 120. This multi-surface positioning creates a three-dimensional bracing system that distributes structural loads across both the front and rear planes of the panel assembly, providing improved resistance to various loading conditions including wind forces, seismic activity, and thermal expansion effects.

The rear surface positioning of diagonal bracings allows for structural reinforcement that may be concealed from view when the noise abatement panel is installed in its final configuration. In some cases, the rear surface diagonal bracing may be positioned to provide structural support without interfering with the aesthetic appearance of the front-facing surface of the panel. The rear surface diagonal bracing may extend from upper joint locations at intersections of horizontal frame members with end posts down to lower joint locations at intersections of horizontal frame members with intermediate vertical frame members, creating load transfer paths that complement the structural performance of front surface diagonal bracings.

The front surface positioning of diagonal bracings provides structural reinforcement that may be integrated with the overall design aesthetic of the noise abatement panel. In some cases, the front surface diagonal bracing may be positioned to provide both structural support and visual design elements that enhance the architectural appearance of the completed panel assembly. The front surface diagonal bracing may follow similar connection patterns as the rear surface bracing, with upper joints positioned at frame member intersections and lower joints located at intermediate support points throughout the rigid frame structure.

The combination of front and rear surface diagonal bracings creates a distributed bracing system that may provide enhanced structural performance compared to single-surface bracing configurations. In some cases, the multi-surface arrangement allows for load distribution across multiple planes of the rigid frame, reducing stress concentrations at individual connection points and improving overall structural integrity under various loading scenarios. The front and rear surface diagonal bracings may be positioned to avoid interference with each other while maintaining independent load paths that contribute to the overall structural capacity of the noise abatement panel assembly.

The spatial relationship between front and rear surface diagonal bracings may be configured to optimize structural performance while accommodating manufacturing and installation requirements. In some cases, the front and rear surface bracings may be positioned at different angular orientations or connection points to maximize structural effectiveness without creating assembly conflicts or installation complications. The multi-surface bracing arrangement may also accommodate the integration of additional panel components such as insulation layers, sheathing materials, and cover layers without compromising the structural integrity or accessibility of the diagonal bracing connections.

The diagonal bracings 122 may be arranged about a vertical axis extending through the top rail 126a and the bottom rail 126b to provide enhanced structural coordination and load distribution throughout the noise abatement panel assembly. As depicted in FIG. 11, first diagonal bracing 122a and second diagonal bracing 122b are arranged about a vertical axis. In a similar manner in FIG. 12, the pair of first diagonal bracing 122a and third diagonal bracing 122c are arranged about one side of the vertical axis and the pair second diagonal bracing 122b and fourth diagonal bracing 122d are arranged about the other side of the vertical axis. In some cases, the vertical axis arrangement creates a centralized reference point that allows for systematic positioning of diagonal bracing elements while maintaining structural balance across the rigid frame. The vertical axis may extend longitudinally through the geometric center of the rigid frame, providing a reference line that guides the placement and orientation of diagonal bracings to achieve optimal load transfer characteristics. The arrangement about the vertical axis may allow for symmetrical distribution of structural forces, reducing potential stress concentrations that could occur with asymmetrical bracing configurations.

The vertical axis configuration may provide advantages in terms of manufacturing consistency and installation procedures, as the centralized reference system allows for standardized positioning of diagonal bracing elements across multiple panel assemblies. In some cases, the vertical axis arrangement facilitates quality control during manufacturing processes by providing a consistent geometric reference that can be used to verify proper positioning and alignment of diagonal bracings. The vertical axis may also serve as a reference point for field installation procedures, allowing installation crews to verify proper panel orientation and alignment during construction activities.

The at least two nonintersecting diagonal bracings may be vertically offset to create distributed load paths that enhance structural performance under various loading conditions. As depicted in FIG. 12, first diagonal bracing 122a is vertically offset from third diagonal bracing 122c and second diagonal bracing 122b is vertically offset from fourth diagonal bracing 122d. In some cases, the vertically offset configuration positions individual diagonal bracings at different elevations within the rigid frame, creating multiple load transfer zones that distribute structural forces across a broader area of the frame assembly. The vertical offset arrangement may prevent load concentration at single elevation points, instead spreading structural forces across multiple horizontal frame members and connection points throughout the rigid frame structure.

The vertically offset positioning may provide enhanced resistance to dynamic loading conditions such as wind forces or seismic activity, as the distributed bracing system creates multiple energy dissipation paths that can accommodate various directional forces. In some cases, the vertical offset configuration allows for independent load transfer characteristics for each diagonal bracing element, reducing the potential for structural failure modes that could affect multiple bracing elements simultaneously. The offset arrangement may also accommodate manufacturing tolerances and field installation variations while maintaining consistent structural performance across the entire panel assembly.

The vertically offset diagonal bracings may be positioned at predetermined spacing intervals that optimize structural performance while accommodating other panel components such as insulation layers and sheathing materials. In some cases, the vertical spacing between offset diagonal bracings may be calculated based on structural load requirements, frame member dimensions, and connection capacity limitations to ensure adequate load transfer without overstressing individual frame components. The offset configuration may also provide flexibility for accommodating specialized panel features such as access doors or windows without compromising the overall structural integrity of the diagonal bracing system.

The at least two nonintersecting diagonal bracings may be arranged in parallel to create coordinated load transfer paths that work in conjunction to distribute structural forces throughout the rigid frame assembly. In an exemplary aspect as depicted in FIG. 12, first diagonal bracing 122a is arranged in parallel with third diagonal bracing 122c, and second diagonal bracing 122b is arranged in parallel with fourth diagonal bracing 122d. In some cases, the parallel arrangement positions diagonal bracings at similar angular orientations while maintaining the nonintersecting configuration that prevents physical interference between individual bracing elements. The parallel positioning may create redundant load paths that provide enhanced structural reliability, as multiple diagonal bracings can share load transfer responsibilities under various loading scenarios.

The parallel arrangement of diagonal bracings may provide advantages in terms of load distribution symmetry, as similarly oriented bracing elements can create balanced force transfer patterns that reduce potential torsional effects within the rigid frame structure. In some cases, the parallel configuration allows for consistent connection details and fastening procedures across multiple diagonal bracing elements, simplifying manufacturing processes and reducing the potential for installation errors. The parallel positioning may also facilitate maintenance and inspection procedures, as similarly configured bracing elements can be evaluated using consistent assessment criteria and replacement procedures.

The combination of vertically offset and parallel arrangements may create a sophisticated bracing system that provides enhanced structural performance compared to single-configuration bracing approaches. In some cases, the vertically offset parallel diagonal bracings may be positioned to create overlapping load transfer zones that provide continuous structural support across the entire height of the rigid frame assembly. The combined configuration may accommodate various panel dimensional requirements while maintaining consistent structural characteristics, allowing for standardized design approaches across different panel sizes and applications.

The parallel arrangement may also accommodate the integration of additional structural elements such as vertical bracings 123 or intermediate frame members without creating assembly conflicts or reducing structural effectiveness. In some cases, the parallel diagonal bracing configuration may be coordinated with other structural elements to create a comprehensive reinforcement system that addresses multiple loading scenarios and structural requirements. The parallel positioning may provide flexibility for future modifications or upgrades to the panel assembly while maintaining the structural integrity of the existing diagonal bracing system.

The noise abatement panel may further comprise a plurality of vertical bracings 123 (123a, 123b, . . . , 123n) that provide additional structural reinforcement to complement the diagonal bracing system described above. The plurality of vertical bracings 123 may be constructed from similar materials as the diagonal bracings, such as cold-rolled steel strapping or other suitable metallic materials that provide adequate tensile strength and durability for structural applications. In some cases, the vertical bracings 123 may be dimensioned to match or complement the diagonal bracing elements, with typical dimensions of approximately 2 inches wide by 16 gauge thickness, though other dimensions may be selected based on specific structural requirements and load conditions. The vertical bracings 123 may be positioned to work in conjunction with the existing rigid frame structure and diagonal bracing system to create a comprehensive reinforcement network that distributes loads across multiple structural pathways.

Each of the plurality of vertical bracings 123 may be aligned with at least a portion of a corresponding one of the plurality of intermediate vertical frame members 124 to create coordinated load transfer mechanisms throughout the rigid frame assembly. The alignment configuration allows the vertical bracings 123 to work in conjunction with the existing intermediate vertical frame members 124, creating redundant load paths that enhance the overall structural capacity of the noise abatement panel. In some cases, the vertical bracings 123 may be positioned parallel to the intermediate vertical frame members 124, creating a dual-element system where both the frame member and the vertical bracing contribute to load transfer and structural stability. The alignment may extend along the full length of the intermediate vertical frame members 124 or may cover specific portions where additional reinforcement is needed based on structural analysis and load distribution requirements.

In exemplary aspects as depicted in FIGS. 11-13, the partial overlap of the vertical bracings 123 with the intermediate vertical frame members 124 may be visually indicated by hatching or cross-hatching provided on the vertical bracings 123, the absence of which may indicate portions of the intermediate vertical frame members 124 for which the vertical bracings 123 does not overlap and align.

The alignment relationship between the vertical bracings 123 and the intermediate vertical frame members 124 may provide enhanced resistance to various loading conditions including wind forces, seismic activity, and thermal expansion effects. In some cases, the aligned configuration creates a composite structural element that combines the load-bearing capacity of the intermediate vertical frame member with the additional reinforcement provided by the vertical bracing. The alignment may be maintained through mechanical fastening systems that connect the vertical bracing directly to the intermediate vertical frame member at multiple points along their length, creating a unified structural element that functions as a single load-bearing component.

The vertical bracings 123 may be positioned to accommodate the integration of other panel components such as insulation layers, sheathing materials, and cover layers without compromising their structural effectiveness or accessibility for maintenance procedures. In some cases, the vertical bracings 123 may be recessed or positioned to allow for proper installation of sheathing materials while maintaining their alignment with the intermediate vertical frame members 124. The positioning may also consider thermal expansion characteristics of the various materials to prevent binding or stress concentration that could occur due to differential thermal movement between the vertical bracings 123 and other panel components.

The plurality of vertical bracings 123 may be distributed across the rigid frame assembly to provide balanced structural reinforcement that complements the load distribution characteristics of the diagonal bracing system. In some cases, the vertical bracings 123 may be positioned at predetermined spacing intervals that correspond to the locations of intermediate vertical frame members 124, creating a systematic reinforcement pattern that addresses structural requirements across the entire panel assembly. The distribution pattern may be configured to provide enhanced structural performance in areas where concentrated loads are anticipated, such as connection points with adjacent panels or mounting locations for hardware and accessories.

The connection details for the vertical bracings 123 may incorporate standardized fastening procedures that accommodate both manufacturing efficiency and field installation requirements. In some cases, the vertical bracings 123 may be attached to the intermediate vertical frame members 124 using mechanical fasteners such as screws, bolts, or specialized clips that provide secure connections while allowing for potential removal or replacement during maintenance operations. The connection system may be designed to transfer loads effectively between the vertical bracing 123 and the intermediate vertical frame member while accommodating manufacturing tolerances and installation variations that may occur during panel assembly or field installation procedures.

The vertical bracing system may provide enhanced structural performance characteristics that complement the diagonal bracing system to create a comprehensive reinforcement network throughout the noise abatement panel assembly. In some cases, the combination of vertical bracings 123 and diagonal bracings 122 creates multiple load transfer pathways that can accommodate various loading scenarios and provide redundant structural capacity in the event of localized stress concentrations or material degradation. The vertical bracings 123 may also contribute to the overall stiffness of the panel assembly, reducing deflections under service loads and helping to maintain the panel within acceptable deflection limits such as the L/240 criteria specified in the design requirements.

The diagonal bracings 122 may be configured with specific joint positioning arrangements that optimize load transfer characteristics and structural performance throughout the noise abatement panel assembly. In some cases, the upper joint of each of the at least two nonintersecting diagonal bracings may be arranged at an intersection of the top rail 126a and a corresponding one of the first end post 124a or the second end post 124b. This positioning creates a direct load transfer path from the uppermost portion of the rigid frame structure down through the diagonal bracing elements to lower connection points within the frame assembly. The intersection of the top rail 126a with the end posts represents a high-strength connection zone where multiple structural elements converge, providing an ideal anchor point for diagonal bracing elements that may experience significant tensile and compressive forces during service conditions.

The positioning of upper joints at the intersection of the top rail 126a and end posts may provide enhanced structural coordination between the primary frame elements and the diagonal bracing system. In some cases, this configuration allows the diagonal bracings 122 to participate directly in the load transfer mechanisms of the top rail 126a, which may experience significant bending moments and axial forces due to wind loading, seismic activity, or other environmental conditions. The connection at this intersection point may distribute loads from the top rail 126a into the diagonal bracing elements, creating multiple load paths that reduce stress concentrations within individual frame components. The upper joint positioning may also provide enhanced resistance to lateral loading conditions, as the diagonal bracings can transfer lateral forces from the top rail 126a down to intermediate support points within the rigid frame structure.

The structural advantages of positioning upper joints at top rail 126a and end post intersections may include improved load distribution characteristics and enhanced overall frame stability. In some cases, this configuration creates a triangulated load transfer system where forces applied to the top rail 126a are distributed through both the vertical end posts and the diagonal bracing elements, reducing the potential for localized stress concentrations that could lead to structural failure. The intersection positioning may also provide enhanced resistance to torsional loading conditions, as the diagonal bracings can resist twisting forces that might otherwise cause the rigid frame to deform under asymmetrical loading scenarios. The upper joint configuration may accommodate various connection methods including mechanical fasteners, welded connections, or specialized hardware that provides secure attachment while allowing for manufacturing tolerances and installation variations.

The lower joint of each of the at least two nonintersecting diagonal bracings 122 may be arranged at an intersection of the bottom rail 126b and a corresponding one of the plurality of intermediate vertical frame members 124. This positioning creates a distributed load transfer system where forces transmitted through the diagonal bracings are transferred to intermediate support points rather than concentrating at the end posts of the rigid frame structure. In some cases, the connection to intermediate vertical frame members 124 allows the diagonal bracing system to engage multiple vertical load paths simultaneously, creating redundant structural capacity that enhances the overall reliability of the noise abatement panel assembly. The intersection of the bottom rail 126b with intermediate vertical frame members 124 provides stable connection points that can accommodate the various force directions that may be transmitted through the diagonal bracing elements during different loading scenarios.

The positioning of lower joints at intersections of the bottom rail 126b with intermediate vertical frame members 124 may provide enhanced load distribution compared to configurations where all diagonal bracing elements terminate at the end posts. In some cases, this arrangement creates a more uniform stress distribution throughout the rigid frame structure by engaging multiple vertical frame members 124 in the load transfer process. The intermediate vertical frame member connections may reduce the potential for stress concentrations at the end posts, which might otherwise experience excessive loading if all diagonal bracing elements terminated at these locations. The lower joint positioning may also provide enhanced structural redundancy, as the failure of a single intermediate vertical frame member would not compromise the entire diagonal bracing system due to the distributed connection arrangement.

The combination of upper joints positioned at top rail 126a and end post intersections with lower joints positioned at bottom rail 126b and intermediate vertical frame member intersections may create an optimized load transfer configuration that balances structural efficiency with manufacturing practicality. In some cases, this arrangement allows the diagonal bracing system to engage both the primary structural elements (top rail 126a, bottom rail 126b, end posts 124a, 124b) and the secondary structural elements (intermediate vertical frame members 124) in a coordinated manner that maximizes the structural capacity of the entire rigid frame assembly. The specific joint positioning may accommodate various panel dimensional requirements while maintaining consistent structural performance characteristics across different panel sizes and configurations.

The structural advantages of this specific joint positioning arrangement may include enhanced resistance to various loading conditions and improved overall structural reliability compared to alternative bracing configurations. In some cases, the combination of end post connections at the upper joints with intermediate vertical frame member connections at the lower joints creates a load transfer pattern that distributes forces across multiple structural pathways, reducing the potential for catastrophic failure modes that could affect the entire panel assembly. The joint positioning may also provide enhanced flexibility for accommodating manufacturing tolerances and field installation variations while maintaining the structural integrity of the diagonal bracing system throughout the service life of the noise abatement panel.

The plurality of diagonal bracings 122 may comprise a first pair of nonintersecting diagonal bracings and a second pair of nonintersecting diagonal bracings that work in coordination to provide enhanced structural reinforcement across different sections of the noise abatement panel assembly. The multiple pair configuration creates a distributed bracing system that addresses various loading scenarios and structural requirements throughout different elevations of the rigid frame structure. In some cases, the first pair of nonintersecting diagonal bracings may be positioned to address structural loads and reinforcement needs in upper portions of the rigid frame, while the second pair of nonintersecting diagonal bracings may be configured to provide structural support in lower portions of the frame assembly. The dual pair arrangement allows for systematic load distribution across multiple structural zones, creating redundant load paths that enhance the overall structural reliability and performance characteristics of the noise abatement panel under various service conditions.

The first pair of nonintersecting diagonal bracings may be configured with specific joint positioning arrangements that optimize load transfer from the uppermost portions of the rigid frame structure. In some cases, the upper joint of each of the first pair of nonintersecting diagonal bracings (122a, 122b) may be arranged at an intersection of the top rail 126a and a corresponding one of the first end post 124a or the second end post 124b. This positioning creates direct load transfer pathways from the top rail 126a, which may experience significant loading from wind forces, seismic activity, or other environmental conditions, down through the diagonal bracing elements to intermediate support points within the rigid frame assembly. The connection at the intersection of the top rail 126a with the end posts provides a high-strength anchor point where multiple structural elements converge, allowing the first pair of diagonal bracings to participate directly in the primary load transfer mechanisms of the rigid frame structure.

The lower joint positioning of the first pair of nonintersecting diagonal bracings (122a, 122b) may be configured to distribute loads to intermediate structural elements rather than concentrating forces at the end posts of the rigid frame. In some cases, the lower joint of each of the first pair of nonintersecting diagonal bracings may be arranged at an intersection of one of the plurality of horizontal frame members 126 and a corresponding one of the plurality of intermediate vertical frame members 124. This configuration creates a load transfer system where forces transmitted through the first pair of diagonal bracings are distributed to intermediate vertical frame members 124, engaging multiple vertical load paths simultaneously and creating redundant structural capacity throughout the upper portion of the rigid frame assembly. The connection to intermediate vertical frame members 124 may reduce stress concentrations that might otherwise occur if all diagonal bracing elements terminated at the end posts, providing enhanced load distribution characteristics across the rigid frame structure.

The positioning flexibility of the first pair of nonintersecting diagonal bracings allows for various configuration options that can accommodate different structural requirements and panel dimensional specifications. In some cases, the upper joint of each of the first pair of nonintersecting diagonal bracings (122c, 122d) may be arranged at an intersection of a corresponding one of at least one of the plurality of horizontal frame members and one of the first end post 124a or the second end post 124b. This broader positioning capability allows the first pair of diagonal bracings to be configured for specific structural applications where the upper connection points may need to be positioned at intermediate horizontal frame members rather than exclusively at the top rail 126a. The flexible positioning may accommodate various panel heights, loading conditions, or architectural requirements while maintaining the structural effectiveness of the diagonal bracing system.

The lower joint positioning of the first pair of nonintersecting diagonal bracings may similarly provide flexibility for accommodating various structural configurations and load distribution requirements. In some cases, the lower joint of each of the first pair of nonintersecting diagonal bracings (122c, 122d) may be arranged at an intersection of a corresponding one of the plurality of horizontal frame members and one of the plurality of intermediate vertical frame members 124. This configuration allows the lower connection points to be positioned at various elevations within the rigid frame structure, creating customized load transfer patterns that can address specific structural requirements or accommodate other panel components such as access doors, windows, or specialized hardware mounting locations. The flexible lower joint positioning may provide enhanced design versatility while maintaining the structural integrity and load transfer capabilities of the first pair of diagonal bracings.

The second pair of nonintersecting diagonal bracings may be configured with distinct positioning arrangements that complement the structural reinforcement provided by the first pair while addressing different loading zones within the rigid frame assembly. In some cases, the upper joint of each of the second pair of nonintersecting diagonal bracings may be arranged at an intersection of an intermediate one of the plurality of horizontal frame members and a corresponding one of the first end post 124a or the second end post 124b. This positioning creates load transfer pathways from intermediate elevations within the rigid frame structure, allowing the second pair of diagonal bracings to address structural loads that may occur in the middle portions of the panel assembly. The connection to intermediate horizontal frame members provides anchor points that may experience different loading characteristics compared to the top rail 126a connections used by the first pair of diagonal bracings.

The intermediate horizontal frame member connections for the second pair of nonintersecting diagonal bracings may provide enhanced structural coordination between the upper and lower portions of the rigid frame assembly. In some cases, the positioning of upper joints at intermediate horizontal frame members creates a load transfer system that bridges the structural zones addressed by the first pair of diagonal bracings and the lower portions of the rigid frame structure. The intermediate positioning may allow the second pair of diagonal bracings to participate in load transfer mechanisms that involve multiple horizontal frame members simultaneously, creating a more distributed structural system compared to configurations where all diagonal bracing elements connect exclusively to the top rail 126a or bottom rail 126b. The intermediate connections may also provide enhanced resistance to localized loading conditions that might occur at specific elevations within the panel assembly.

The lower joint positioning of the second pair of nonintersecting diagonal bracings may be configured to provide structural reinforcement that complements the load distribution characteristics of the first pair while addressing the lowermost portions of the rigid frame structure. In some cases, the lower joint of each of the second pair of nonintersecting diagonal bracings may be arranged at an intersection of the bottom rail 126b and a corresponding one of the plurality of intermediate vertical frame members 124. This positioning creates direct load transfer pathways from the intermediate horizontal frame member connections down to the bottom rail 126b, which serves as the foundational structural element of the rigid frame assembly. The connection to the bottom rail 126b allows the second pair of diagonal bracings to participate in the primary load transfer mechanisms that distribute forces to the foundation or mounting system of the noise abatement panel.

The combination of intermediate horizontal frame member connections at the upper joints with bottom rail 126b connections at the lower joints creates a load transfer pattern for the second pair of nonintersecting diagonal bracings that addresses different structural zones compared to the first pair. In some cases, this configuration allows the second pair of diagonal bracings to provide structural reinforcement for the lower portion of the rigid frame while maintaining connection to intermediate elevations that may experience specific loading conditions. The bottom rail 126b connections provide stable anchor points that can accommodate various force directions transmitted through the diagonal bracing elements, while the intermediate horizontal frame member connections allow the second pair to engage with structural loads that occur at mid-height locations within the panel assembly.

The coordinated operation of the first pair and second pair of nonintersecting diagonal bracings creates a comprehensive structural reinforcement system that addresses multiple loading zones and provides enhanced redundancy throughout the rigid frame assembly. In some cases, the dual pair configuration allows for load sharing between different diagonal bracing elements, reducing the potential for stress concentrations that might occur with single-pair bracing systems. The multiple pair arrangement may provide enhanced resistance to various loading scenarios including wind forces, seismic activity, thermal expansion effects, and dynamic loading conditions that could affect different portions of the panel assembly simultaneously. The structural coordination between the first pair and second pair may create overlapping reinforcement zones that provide continuous structural support across the entire height of the rigid frame structure.

The multiple pair diagonal bracing system may provide enhanced structural performance characteristics compared to single-pair configurations by creating distributed load paths that engage multiple structural elements throughout the rigid frame assembly. In some cases, the first pair and second pair of nonintersecting diagonal bracings work together to create a load transfer network that can accommodate various failure scenarios and provide continued structural integrity even if individual bracing elements experience degradation or damage. The multiple pair configuration may also provide enhanced flexibility for accommodating manufacturing tolerances, installation variations, and service-related adjustments while maintaining consistent structural performance throughout the service life of the noise abatement panel assembly.

Various modifications and additions can be made to the exemplary embodiments discussed without departing from the scope of the present disclosure. While the embodiments described above refer to particular features, the scope of this disclosure also includes embodiments having different combinations of features and embodiments that do not include all of the described features. The noise abatement panel may be constructed using alternative materials that provide similar structural and functional characteristics while meeting applicable industry standards and performance requirements. In some cases, the rigid frame components may be fabricated from alternative metallic materials such as aluminum alloys, stainless steel, or other corrosion-resistant materials that provide adequate structural capacity for the intended application. The diagonal bracings may similarly be constructed from various metallic materials or composite materials that provide suitable tensile strength and durability characteristics for structural reinforcement applications.

The dimensional specifications of the noise abatement panel may be modified to accommodate various project requirements and installation constraints while maintaining the structural relationships and performance characteristics described herein. In some cases, the panel dimensions may be scaled to accommodate different height requirements, width specifications, or thickness constraints based on specific acoustic performance requirements or architectural design considerations. The spacing between vertical frame members 124 may be adjusted to accommodate different loading conditions or to integrate with various foundation systems and mounting configurations. The thickness of the sheathing layer may be modified to provide enhanced acoustic performance or to accommodate specific coating systems and finish requirements.

The configuration of the diagonal bracing system may be adapted to address various structural requirements and loading scenarios while maintaining the nonintersecting arrangement and joint positioning principles described above. In some cases, additional diagonal bracing elements may be incorporated to provide enhanced structural reinforcement for panels subjected to extreme loading conditions or environmental exposures. The angular orientation of the diagonal bracings may be adjusted to optimize load transfer characteristics for specific applications or to accommodate the integration of specialized panel features such as access doors, windows, or utility penetrations. The connection methods for the diagonal bracings may be modified to incorporate alternative fastening systems, welded connections, or specialized hardware that provides enhanced structural performance or simplified installation procedures.

The cover layer system may be configured using alternative coating materials, application methods, or protective systems that provide similar or enhanced performance characteristics compared to the embodiments described above. In some cases, the cover layer may incorporate specialized coatings such as photocatalytic materials for air purification, reflective coatings for thermal management, or specialized textures for enhanced acoustic absorption. The sheathing layer may be constructed from alternative cementitious materials, composite panels, or other suitable substrate materials that provide adequate structural support and compatibility with the selected cover layer system. The layered construction sequence may be modified to accommodate different manufacturing processes or to integrate additional functional layers such as vapor barriers, thermal insulation, or specialized acoustic materials.

The structural reinforcement system may be enhanced through the incorporation of additional bracing elements, alternative connection methods, or specialized hardware that provides enhanced load transfer capabilities or simplified assembly procedures. In some cases, the vertical bracing system may be expanded to include horizontal bracing elements that provide enhanced resistance to lateral loading conditions or dynamic forces. The connection details between the various structural elements may be modified to incorporate standardized hardware systems, prefabricated connection assemblies, or specialized fastening methods that provide enhanced structural performance while reducing manufacturing complexity and installation time.

The manufacturing methods and assembly sequences described above may be adapted to accommodate various production capabilities, quality control requirements, or installation constraints while maintaining the structural integrity and performance characteristics of the completed panel assembly. In some cases, the manufacturing process may be modified to incorporate automated assembly procedures, prefabrication techniques, or modular construction methods that provide enhanced production efficiency or quality consistency. The installation procedures may be adapted to accommodate various site conditions, equipment limitations, or safety requirements while maintaining the structural connections and performance characteristics described herein.

The acoustic performance characteristics of the noise abatement panel may be enhanced through the incorporation of specialized materials, surface treatments, or geometric configurations that provide enhanced sound absorption, reflection, or transmission loss properties. In some cases, the panel configuration may be modified to incorporate resonant chambers, perforated surfaces, or specialized acoustic materials that provide enhanced performance for specific frequency ranges or noise sources. The aesthetic features of the panel may be customized to accommodate various architectural requirements, environmental considerations, or community preferences while maintaining the structural and acoustic performance characteristics described above.

Accordingly, the scope of the present disclosure is intended to embrace all such alternatives, modifications, and variations as fall within the scope of the appended claims, together with all equivalents thereof. The various embodiments described herein may be combined in different ways to create additional configurations that provide enhanced performance characteristics or address specific application requirements. The structural principles and relationships described above may be applied to panels of various sizes, configurations, and applications while maintaining the fundamental performance characteristics and advantages of the disclosed noise abatement panel system.

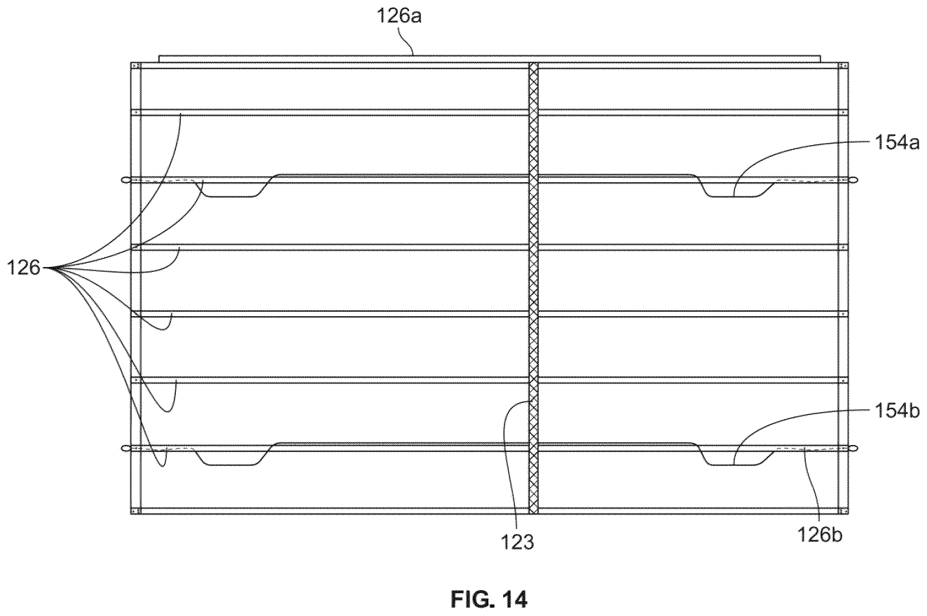

FIG. 14 depicts a frame with an added cable restraint system according an aspect of the present disclosure. In some aspects, the panel 100 may include one or more cables 154a, 154b, . . . , 154n arranged along any one or more of the horizontal frame members 126. The cables 154 may be arranged to extend from the first end post 124a to the second end post 124b through an entire width of a single panel frame. Each of the cables 154 may include a loop or other fixation structure at each end of the cable for securement to an anchoring structure. The cables 154 may be arranged to provide a selectable amount of excess cable relative to the width of the frame 120, such as cable slack, to allow for movement of the cable and corresponding frame before becoming taught.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Although embodiments of the present invention have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A noise abatement panel, comprising:
a rigid frame comprising a plurality of vertical frame members and a plurality of horizontal frame members;
the plurality of horizontal frame members comprising a top rail and a bottom rail; and
the plurality of vertical frame members comprising a first end post, a second end post, and a plurality of intermediate vertical frame members;
a plurality of diagonal bracings comprising at least two nonintersecting diagonal bracings, each diagonal bracing including an upper joint and a lower joint;
the upper joint of each of the at least two nonintersecting diagonal bracings arranged at an intersection of at least one of the plurality of horizontal frame members and a corresponding one of the first end post or the second end post; and
the lower joint of each of the at least two nonintersecting diagonal bracings arranged at an intersection of at least one of the plurality of horizontal frame members and at least one of the plurality of intermediate vertical frame members;
a cover layer; and
a sheathing layer, interposing the cover layer and the rigid frame, comprising cement board.

2. The noise abatement panel of claim 1, wherein:
one of the at least two nonintersecting diagonal bracings is arranged at a rear surface of the rigid frame; and
another of the at least two nonintersecting diagonal bracings is arranged at a front surface of the rigid frame.

3. The noise abatement panel of claim 1, wherein:
the at least two nonintersecting diagonal bracings are arranged about a vertical axis extending through the top rail and the bottom rail.

4. The noise abatement panel of claim 1, wherein:
the at least two nonintersecting diagonal bracings are vertically offset.

5. The noise abatement panel of claim 4, wherein:
the at least two nonintersecting diagonal bracings are arranged in parallel.

6. The noise abatement panel of claim 1, further comprising:
a plurality of vertical bracings.

7. The noise abatement panel of claim 6, wherein:
each of the plurality of vertical bracings are aligned with at least a portion of a corresponding one of the plurality of intermediate vertical frame members.

8. The noise abatement panel of claim 1, wherein:
the upper joint of each of the at least two nonintersecting diagonal bracings is arranged at an intersection of the top rail and a corresponding one of the first end post or the second end post; and
the lower joint of each of the at least two nonintersecting diagonal bracings is arranged at an intersection of the bottom rail and a corresponding one of the plurality of intermediate vertical frame members.

9. The noise abatement panel of claim 1, wherein:
the plurality of diagonal bracings comprises:
a first pair of nonintersecting diagonal bracings; and
a second pair of nonintersecting diagonal bracings.

10. The noise abatement panel of claim 9, wherein:
the upper joint of each of the first pair of nonintersecting diagonal bracings is arranged at an intersection of the top rail and a corresponding one of the first end post or the second end post; and
the lower joint of each of the first pair of nonintersecting diagonal bracings is arranged at an intersection of one of the plurality of horizontal frame members and a corresponding one of the plurality of intermediate vertical frame members.

11. The noise abatement panel of claim 9, wherein:
the upper joint of each of the second pair of nonintersecting diagonal bracings is arranged at an intersection of an intermediate one of the plurality of horizontal frame members and a corresponding one of the first end post or the second end post; and
the lower joint of each of the second pair of nonintersecting diagonal bracings is arranged at an intersection of the bottom rail and a corresponding one of the plurality of intermediate vertical frame members.

12. The noise abatement panel of claim 9, wherein:
the upper joint of each of the first pair of nonintersecting diagonal bracings is arranged at an intersection of a corresponding one of at least one of the plurality of horizontal frame members and one of the first end post or the second end post; and
the lower joint of each of the first pair of nonintersecting diagonal bracings is arranged at an intersection of a corresponding one of the plurality of horizontal frame members and one of the plurality of intermediate vertical frame members.

13. The noise abatement panel of claim 1, wherein:
the cover layer comprises a tactile feature.

14. The noise abatement panel of claim 13, wherein:
the tactile feature is configured to mimic at least one of a tree, a bush, a hedge, a mountain, a hillside, a garden, or a flower.

15. The noise abatement panel of claim 1, wherein:
the cover layer comprises a silicone based anti-graffiti coating.

16. The noise abatement panel of claim 1, further comprising:
a noise-reducing insulation layer,
a weather barrier layer,
a basecoat, and
a mesh coating layer.

17. The noise abatement panel of claim 16, wherein:
the mesh coating layer comprises a fiberglass.

18. The noise abatement panel of claim 1, wherein:
the cover layer comprises an acrylic coating.

19. A method of manufacturing a noise abatement panel, comprising:
providing a plurality of vertical frame members and a plurality of horizontal frame members, the plurality of horizontal frame members comprising a top rail and a bottom rail, and the plurality of vertical frame members comprising a first end post, a second end post, and a plurality of intermediate vertical frame members;
assembling the plurality of vertical frame members and the plurality of horizontal frame members to form a rigid frame;
providing a plurality of diagonal bracings comprising at least two nonintersecting diagonal bracings, each diagonal bracing including an upper joint and a lower joint;
attaching the plurality of diagonal bracings to the rigid frame with the upper joint of each of the at least two nonintersecting diagonal bracings arranged at an intersection of at least one of the plurality of horizontal frame members and a corresponding one of the first end post or the second end post, and the lower joint of each of the at least two nonintersecting diagonal bracings arranged at an intersection of at least one of the plurality of horizontal frame members and at least one of the plurality of intermediate vertical frame members;
applying a sheathing layer comprising cement board to the rigid frame; and
applying a cover layer over the sheathing layer.

20. The method of claim 19, wherein attaching the plurality of diagonal bracings comprises securing one of the at least two nonintersecting diagonal bracings at a rear surface of the rigid frame and securing another of the at least two nonintersecting diagonal bracings at a front surface of the rigid frame.
